(19) United States
(12) Patent Application Publication
(10) Pub. No.: US 2024/0148589 A1
(43) Pub. Date: May 9, 2024

(54) DUAL STRETCHING AND MASSAGE DEVICE

(71) Applicant: Primal Fitness Inc, Galt, CA (US)

(72) Inventor: Taylor Peasha, Galt, CA (US)

(21) Appl. No.: 17/983,679

(22) Filed: Nov. 9, 2022

(51) Int. Cl. A61H 1/02; A61H 15/00

(52) U.S. Cl. CPC A61H 1/02; A61H 15/0092

(57) ABSTRACT

A device for massaging muscles and performing stretching exercises is provided. The device includes a resilient body having at least one notch. The device further includes a cord component extending through the resilient body to form a continuous closed loop. The cord component is adaptable between a first expanded position to facilitate stretching exercises and a second closed position to facilitate storage and transport.

### TECHNICAL FIELD

This disclosure relates generally to exercise equipment and, more particularly, to a lightweight, portable, therapeutic stretching and massage device that is convenient to use for effectively reducing and relieving muscle pain, decreasing risk of muscle soreness and pain and promoting blood flow throughout the body.

### BACKGROUND

It is well known that stretching is a form physical exercise, wherein an individual deliberately flexes or stretches a particular muscle or tendon in order to improve the muscle's elasticity and achieve comfortable muscle tone. Some of the common benefits of daily stretching include increased flexibility and joint range of motion, improved circulation, injury prevention, less muscle soreness, improved posture, and stress relief. Another common form of treating muscle injuries, reducing stress, and relieving muscle pain is to massage the muscle. Massage is the manipulation of the body's soft tissue and may be performed by a person or a device.

Although everyone can benefit from daily stretching, stretching is especially important for hard labor workers, pregnant women, people who drive, sit and fly often and/or for long periods of time and athletes and others that have active lifestyles. Sciatica pain is often problematic during pregnancy as it is estimated that over fifty percent (50%) of women may experience back pain during pregnancy. Furthermore, relaxin is a hormone produced by the ovary and the placenta that has important effects in the female reproductive system and during pregnancy. However, relaxin can cause ligaments to stretch and cause sciatica. Typically, persons having desk occupations, driving long hours or having a relatively sedentary lifestyle experience a higher risk for sciatica. Labor intensive occupations can cause traumatic body impact over time, which can lead to compression on the sciatic nerve and causing numbness or tingling.

There are a number of ways to stretch, including static or dynamic stretching, wherein static stretches are performed while stationary and dynamic stretches involve movement of the muscle during the stretch. Stretches may also be active or passive, wherein active stretches typically utilize internal forces generated by the body while passive stretches utilize forces from external objects to perform the stretch. For example, individuals may use straps, bands, ropes, rollers, balls, and stretching machines. Although it is known to use stretching tools incorporating a ball to stretch, they suffer from certain disadvantages. Specifically, current stretching tools that have a ball used for massage technique do not have an easy way to position the ball on the posterior side of the body. Furthermore, current stretching tools that utilize a ball cannot be used to stretch with an endless looped attached band, i.e., there is no “two in one” stretching and massage tool with a ball and looped band.

Accordingly, there is a need for a stretching tool that incorporates a massage ball with a looped band so that the ball may be easily positioned on the desired part of the user's body by the user for massaging of targeted muscles as well as using the looped band for deeper stretching simultaneously.

### SUMMARY

In accordance with one aspect of the disclosure, a device for massaging muscles and performing stretching exercises is provided. The device includes a resilient body having at least one notch. The device further includes a cord component extending through the resilient body to form a continuous closed loop. The cord component is adaptable between a first expanded position to facilitate stretching exercises and a second closed position to facilitate storage and transport.

In one embodiment, the resilient body is spherically-shaped. The resilient body may be an exercise or massage ball. The resilient body may have at least a partially hollow interior section. The partially hollow interior section may be a cylindrically-shaped channel. The cylindrically-shaped channel may be mounted on a center axis of the resilient body.

In another embodiment, the cord component may be a flexible band. The flexible band may be made of an elastic material. The device may also include an axle clamp for receiving the cord component. The resilient body may be fixed on the axle clamp such that the resilient body does not rotate around the axle clamp. The axle clamp and the cord component may be substantially parallel to one another.

In accordance with another aspect of the disclosure, a stretching and massage tool is provided. The stretching and massage tool includes a ball having at least one notch, a two-piece axle clamp, and a flexible cord having opposed ends. A first end of the flexible cord engages with a first piece of the axle clamp and a second, opposite end of the flexible cord engages with a second piece of the axle clamp such that the cord forms an endless loop.

In one embodiment, the ball may be positioned over the two-piece axle clamp. The first and second pieces of the axle clamp may snap together to form the endless loop for the flexible cord. The at least one notch may be a pair of intersecting grooves. The flexible cord may be configured to extend away from and around the ball in a first stretching position. The tool may further include a locking band positioned on the flexible cord. The locking band may be configured to wrap around the ball in a second stowed position. The locking band may engage the at least one notch to lock the flexible cord in the second stowed position.

In accordance with yet another aspect of the disclosure, a method for transferring a stretching tool from a working position to a storage position is provided. The method includes the step of providing the stretching tool including a flexible cord attached to a massage ball. The method further includes the step of extending the flexible cord away from the massage ball into the working position and wrapping the flexible cord around the massage ball into the storage position. Finally, the method includes the step of locking the stretching tool in the storage position via a band positioned over the flexible cord and engaging a groove located on the massage ball.

### BRIEF DESCRIPTION OF THE DRAWINGS

The accompanying drawings incorporated in and forming a part of the specification, illustrate several aspects of this disclosure, and together with the description serve to explain the principles of the disclosure. In the drawings:

FIG. 1 is a top view of a stretching and massage tool in a first or open position forming one aspect of this disclosure;

FIG. 2 is a front view of the stretching and massage tool in a first or open position forming one aspect of this disclosure;

FIG. 3 is a side view of the stretching and massage tool in a first or open position forming one aspect of this disclosure;

FIG. 4 is a perspective view of the stretching and massage tool in a first or open position forming one aspect of this disclosure; and

FIG. 5 is a perspective view of the stretching tool and massage in a second or storage position forming one aspect of this disclosure.

### DETAILED DESCRIPTION

In the following detailed description, reference is made to the accompanying drawings and photographs that form a part hereof, and in which is shown by way of illustration, specific embodiments in which the invention may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the invention is defined only by the appended claims and their equivalents. In accordance with the disclosure, a stretching and massage tool or device 10 is hereinafter described.

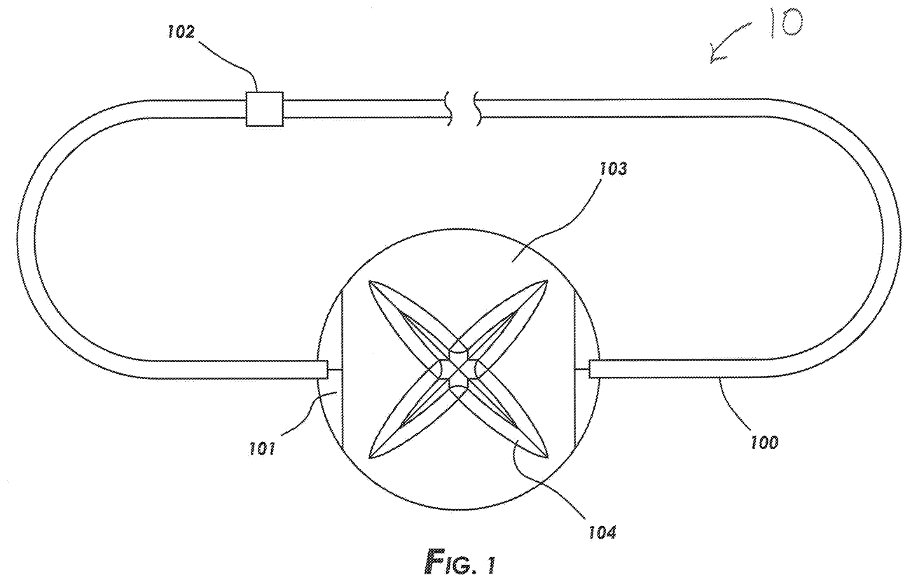

With reference to FIGS. 1-5, the device 10 for massaging and performing stretching exercises is illustrated. The stretching tool 10 includes a resilient body 103 having at least one notch or groove 104. The resilient body 103 is typically spherically-shaped like a ball. For example, the resilient body 103 may be an exercise or massage ball for massage purposes. The resilient body 103 may be built of both firm and semi-firm materials such that it is relatively dense ball with sufficient pliability for applying proper pressure to the individual's muscles during use.

The stretching tool 10 also includes a cord component 100 configured to extend through the resilient body 103 to form a continuous, closed loop to promote stretching exercises. The cord component 100 may be a flexible resistance band or cord having two opposed ends. The flexible band 100 may be comprised of a relatively lightweight and stretchable material, such as latex, rubber or other elastic material. The flexible band 100 should be able to withstand different types of forces without breaking, such as compression and tension forces. The flexible band 100 may vary in length and is designed to expand from its initial length in a non-extended or relaxed position. The flexible band 100 is further designed to require more force to continue to stretch as the band is stretched. The flexible band 100 may have different tensile strengths by resistance of the stretch used on the tool 10.

The resilient body 103 has at least a partially hollow interior section. The hollow interior section may be a cylindrically-shaped channel mounted on a center axis of the resilient body 103 to receive an axle clamp 101. The resilient body 103 is configured to fit over the axle clamp 101, i.e., the middle or conjoining piece of the ball is positioned over the axle clamp in order to provide durability to the cord component 100 and the resilient body 103 while being applied to the user. The axle clamp 101 may be a two-piece unit wherein a first piece engages a first end of the cord component 100 and a second piece engages a second, opposed end of the cord component to form a continuous, closed loop. Once each piece of the axle clamp 101 engages or connects to the respective ends of the cord component 100, the pieces may snap together to form the continuous loop. The snapped together pieces of the axle clamp 101 are positioned within the interior of the resilient body 103. The resilient body 103 is fixed on the axle clamp 101 such that the resilient body does not rotate around the axle clamp. In order words, the resilient body 103 is stationary on the cord component 100 and cannot slide along the cord component. The axle clamp 101 and the cord component 100 are substantially parallel to one another, which gives the resilient body a more economical way to use the device 10. Because the cord component 100 runs parallel through the axle clamp 101, the cord component is allowed to lock in place and isolate the components in one location.

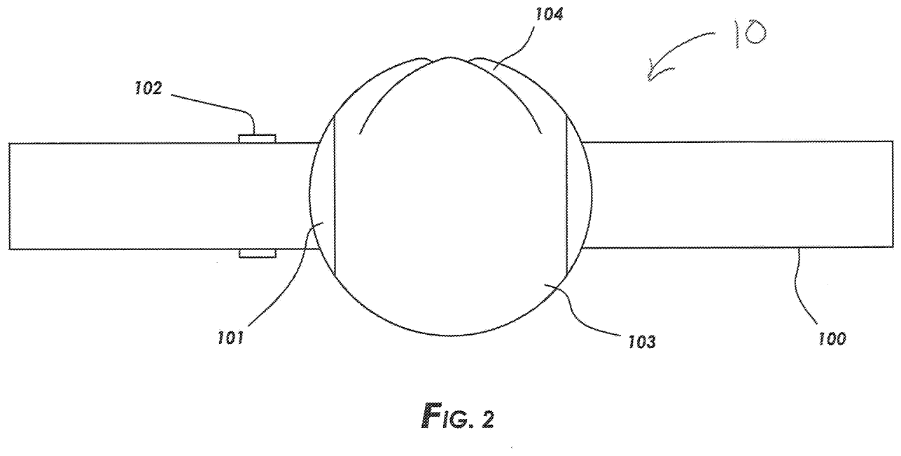

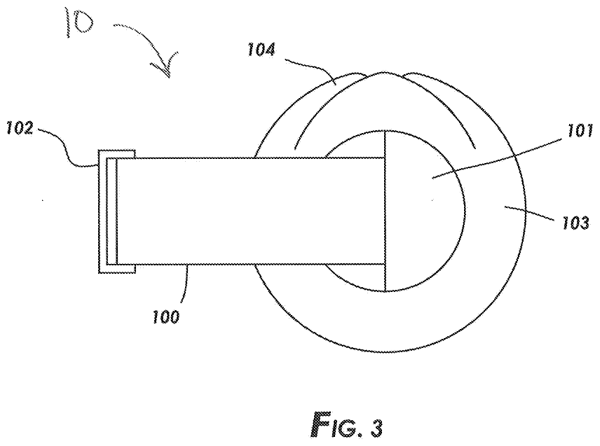

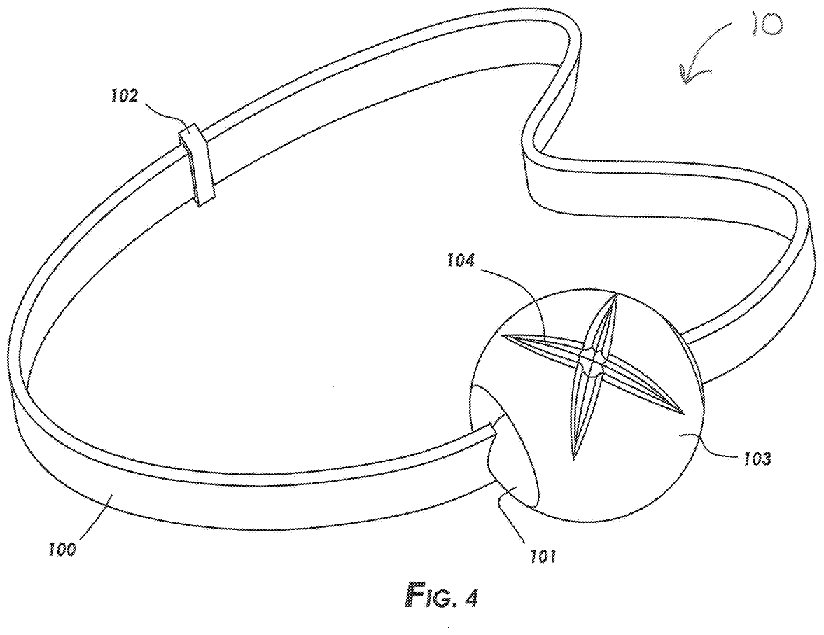

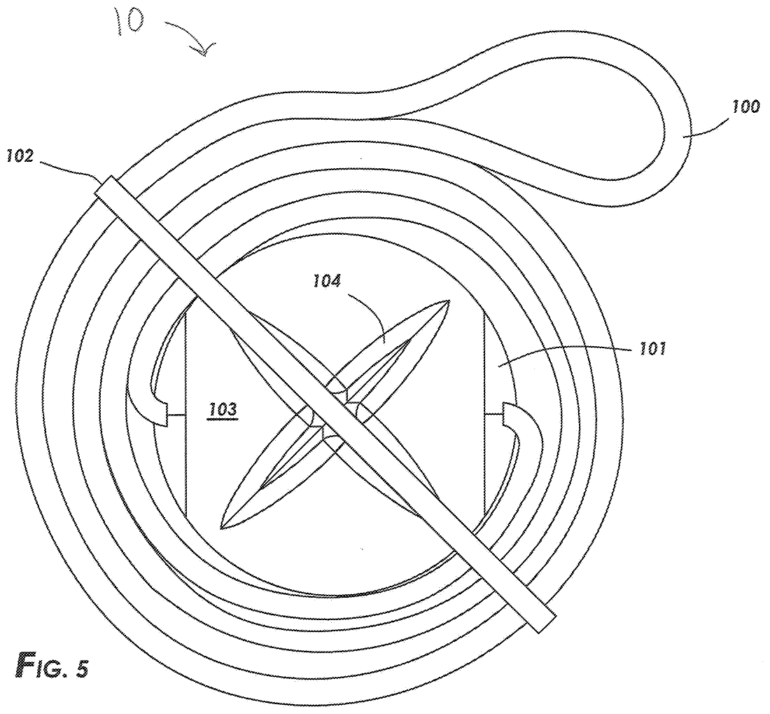

As perhaps best shown in FIGS. 1 and 4, the resilient body 103 has at least one notch 104 positioned thereon. In the illustrated embodiment, the at least one notch 104 is a pair of intersecting grooves. The intersecting grooves 104 are recessed into the resilient body 103. Turning to FIGS. 2 and 3, the cord component 100 has at least one locking band 102 located thereon. In one embodiment, the locking band 102 may be an oversized rubber band that wraps over the cord component 100 and fits within the groove 104 (as shown in FIG. 5) when the cord component is wrapped around the resilient body 103 in a stored position to secure or lock the cord component in place for easier storage and/or transport.

In use, the device 10 may initially be in its storage position shown in FIG. 5. In this position, the device takes up minimal space such that it is compact and easily suitable for storage and transport to any desired location for stretching. For example, the device may be used in numerous places, such as an individual's home, a gym or workout area or on the go, i.e., hotel rooms. Once the individual is at the desired place to stretch, the locking band 102 may be easily removed and the cord component 100 unwrapped from the resilient body 103 as best shown in FIG. 4. In this extendable or working position, an individual may use the device 10 to perform numerous stretching exercises and massage different muscles.

Specifically, the individual may easily position the resilient body or massage ball 103 on their body and use the looped band 100 as a stretching tool. The ball and band work in conjunction to provide a two-in-one experience for the user, i.e., the ball 103 is primarily for massaging muscles, while the band 100 allows for different stretching techniques. The therapeutic device 10 is especially easy to use against a wall for massaging piriformis muscles. The precision of targeted muscles is extremely easy with this device 10 by using the flexible band 100 to locate the therapeutic ball 103 in the trouble area of the piriformis muscle and then apply appropriate pressure to provide a low pressure massage to one's deep tissue areas. Namely, the ball and band being connected and used together in tandem allows users to “sink in” to the stretches by utilizing the pliable material in the device 10 for deeper stretching. The device 10 is easy to use as the ball may be placed precisely where needed on the user's lower back or buttocks without fumbling around.

After the individual finishes his or her stretching and massaging routine, the device 10 may easily be converted back to the storage position shown in FIG. 5. Specifically, the cord component 100 may be wrapped around the ball 103 in a manner wherein the at least one notch 104 remains exposed. Once the cord component 100 is completely wrapped around the ball 103, the locking band 102 may be placed over the cord component and engaged with the groove or notch 104 to securely lock the band in place. In this position, the device takes up minimal space and, therefore, is ideal for storage and transport purposes.

The device 10 disclosed herein offers a number of advantages. Specifically, using the device 10 up to ten minutes twice a day can effectively reduce sciatic issues throughout the body. Daily use of the device 10 creates a healthier spine and body, which promotes a more positive, relaxed, and confident lifestyle. The device 10 is also quite easy to use and is adaptable for a variety of stretching exercises and massaging numerous muscles. The device 10 is convenient to use for effectively reducing and relieving muscle pain caused by the sciatic nerve. However, it is not limited to alleviating pain caused by the sciatic nerve as it is also helpful in decreasing risk of muscle soreness and pain and promoting blood flow throughout the body. Even if an individual is not experiencing sciatic pain, use of the device 10 is designed to decrease one's risk of lumbar, buttock, hip and leg pain. Due to its design and ease in use, any individual should be able to enjoy the benefits of the device 10, i.e., old, young, tall, small, overweight and lightweight individuals may use it. Finally, the portable and compact nature of the device 10 allows it to be easily stored or transported to any location the user desires.

The foregoing descriptions of various embodiments have been presented for purposes of illustration and description. These descriptions are not intended to be exhaustive or to limit the invention to the precise forms disclosed. The embodiments described provide the best illustration of the inventive principles and their practical applications to thereby enable one of ordinary skill in the art to utilize the disclosure in various embodiments and with various modifications as are suited to the particular use contemplated.

1. A device for massaging muscles and performing stretching exercises, comprising:
a resilient body having at least one notch; and
a cord component extending through the resilient body to form a continuous closed loop,
whereby the cord component is adaptable between a first expanded position to facilitate stretching exercises and a second closed position to facilitate storage and transport.

2. The device according to claim 1, wherein the resilient body is spherically-shaped.

3. The device according to claim 1, wherein the resilient body is an exercise or massage ball.

4. The device according to claim 1, wherein the resilient body has at least a partially hollow interior section.

5. The device according to claim 4, wherein the partially hollow interior section is a cylindrically-shaped channel.

6. The device according to claim 5, wherein the cylindrically-shaped channel is mounted on a center axis of the resilient body.

7. The device according to claim 1, wherein the cord component is a flexible band.

8. The device according to claim 7, wherein the flexible band is made of an elastic material.

9. The device according to claim 1, further comprising an axle clamp for receiving the cord component.

10. The device according to claim 9, wherein the resilient body is fixed on the axle clamp such that said resilient body does not rotate around said axle clamp.

11. The device according to claim 9, wherein the axle clamp and the cord component are substantially parallel to one another.

12. A stretching and massage tool, comprising:
a ball having at least one notch;
a two-piece axle clamp; and
a flexible cord having opposed ends, wherein a first end engages with a first piece of the axle clamp and a second, opposite end engages with a second piece of the axle clamp such that the cord forms an endless loop.

13. The tool according to claim 12, wherein the ball is positioned over the two-piece axle clamp.

14. The tool according to claim 12, wherein the first and second pieces of the axle clamp snap together to form the endless loop for the flexible cord.

15. The tool according to claim 12, wherein the at least one notch is a pair of intersecting grooves.

16. The tool according to claim 12, wherein the flexible cord is configured to extend away from and around the ball in a first stretching position.

17. The tool according to claim 12, further comprising a locking band positioned on the flexible cord.

18. The tool according to claim 17, wherein the locking band is configured to wrap around the ball in a second stowed position.

19. The tool according to claim 18, wherein the locking band engages the at least one notch to lock the flexible cord in the second stowed position.

20. A method for transferring a stretching tool from a working position to a storage position, comprising:
providing the stretching tool including a flexible cord attached to a massage ball;
extending the flexible cord away from the massage ball into the working position;
wrapping the flexible cord around the massage ball into the storage position; and
locking the stretching tool in the storage position via a band positioned over the flexible cord and engaging a groove located on the massage ball.
